(19) United States
(12) Patent Application Publication
(10) Pub. No.: US 2010/0195789 A1
(43) Pub. Date: Aug. 5, 2010

(54) Radiographic image capturing system and radiographic image capturing method

(75) Inventors: Eiichi Kanagawa, Minami-ashigara-shi (JP); Jun Enomoto, Kanagawa-ken (JP); Sadato Akahori, Odawara-shi (JP); Yasunori Ohta, Yokohama-shi (JP); Hirofumi Sawada, Minami-ashigara-shi (JP); Tomoyoshi Nishimura, Tokyo (JP); Noriaki Ida, Minami-ashigara-shi (JP)

Correspondence Address: AKERMAN SENTERFITT, 8100 BOONE BOULEVARD, SUITE 700, VIENNA, VA, 22182-2683, US

(73) Assignee: FUJIFILM Corporation, Tokyo (JP)

(21) Appl. No.: 12/656,394

(22) Filed: Jan. 28, 2010

(30) Foreign Application Priority Data
Jan. 30, 2009 (JP) 2009-019350

(51) Int. Cl. G01N 23/00

(52) U.S. Cl. 378/11

(57) ABSTRACT

Tomographic image data acquired by a tomosynthesis image capturing assembly are output from an image output unit to an image processor, and are processed for generating a reconstructed tomographic image. In this case, a part of data is selectively and step by step output from the image output unit to the image processor for reconstruction. Before generating a complete tomographic image, the interim result of the tomographic image is displayed on a display unit.

### CROSS-REFERENCE TO RELATED APPLICATION

This application is based upon and claims the benefit of priority from Patent Application No. 2009-019350 filed on Jan. 30, 2009, in the Japan Patent Office, of which the contents are incorporated herein by reference.

### BACKGROUND OF THE INVENTION

1. Field of the Invention

The present invention relates to a radiographic image capturing system and a radiographic image capturing method for generating a reconstructed tomographic image used in tomosynthesis by processing a plurality of projection images.

2. Description of the Related Art

Heretofore, generation of a tomographic image (reconstructed tomographic image) for tomosynthesis has been performed at a desired sectional position (slice height) in a subject by irradiating the subject with radiation beams emitted from a radiation source at different angles, detecting the radiation beams that have passed through the subject with a radiation detector and converting the detected radiation beams into projection images, and reconstructing the tomographic image from the converted projection images. For example, Japanese Laid-Open Patent Publication No. 2008-119457 discloses an image processing apparatus for generating such a tomographic image, which is capable of generating and displaying a high quality image fast.

According to the related art disclosed in Japanese Laid-Open Patent Publication No. 2008-119457, however, an appropriate radiographic image cannot be obtained by the radiation detector when, for example, the subject has undesirably moved from a predetermined position during the image capturing because the radiographic image will contain an image blur. In this case, since the captured result cannot be confirmed until a certain period of time has elapsed after the capturing of the image, it is necessary to bring the subject back and recapture an image. Therefore, there is concern about the troublesome recapturing of the image and the lowering of the efficiency of image capturing operation, as well as the heavy burden on the subject.

### SUMMARY OF THE INVENTION

It is an object of the present invention to provide a radiographic image capturing system and a radiographic image capturing method which are capable of quickly and certainly judging whether the captured result is appropriate or not, and efficiently performing an image capturing operation.

According to the present invention, the above object can be achieved by a radiographic image capturing system comprising a radiation source for applying radiation to a subject at a plurality of different angles with respect to the subject, a radiation detector for detecting the radiation which has passed through the subject, and acquiring projection image data, a tomographic image reconstructing unit for processing the projection image data into a reconstructed tomographic image, and a display unit. The tomographic image reconstructing unit includes an interim tomographic image generator for generating an interim tomographic image by combining the acquired projection image data with at least one set of other projection image data acquired in advance, each time the projection image data are acquired. The display unit revises and displays the interim tomographic image generated by the interim tomographic image generator, each time the projection image data are acquired.

According to the present invention, a radiographic image capturing system comprises a radiation source for applying radiation to a subject at a plurality of different angles with respect to the subject, a radiation detector for detecting the radiation which has passed through the subject and acquiring projection image data. In the system, an interim tomographic image is generated by an interim tomographic image generator by combining the acquired projection image data with at least one set of other projection image data acquired in advance, each time the projection image data are acquired. Thus, before generating a complete tomographic image, the interim tomographic image as an interim result can be displayed on the display unit and confirmed.

Accordingly, since it is possible to quickly confirm whether the captured result is appropriate or not, the present image capturing can be discontinued or stopped instantly to start recapturing, if the image capturing fails, for example, due to the unwanted movement of the subject from a predetermined position during the image capturing. As a result, it is possible to avoid a troublesome case in which after capturing the image the subject should be brought back for recapturing the image. Also, the burden on the subject can be reduced. Compared to a related art in which the captured result cannot be confirmed until after the capturing of the image has been completed, the image capturing operation can be performed efficiently.

Further, a radiographic image capturing method according to the present invention, wherein radiation is applied to a subject at a plurality of different angles with respect to the subject, and the radiation which has passed through the subject is detected, the method comprises the steps of converting the detected radiation at the different angles into respective sets of projection image data, generating an interim tomographic image based on the projection image data selectively output from among the sets of converted projection image data, and displaying the generated interim tomographic image.

Further, in the generating step, preferably, after a first interim tomographic image is generated from the projection image data acquired in a state in which a radiation source and a radiation detector are positioned perpendicularly to the subject, a next interim tomographic image may be generated step by step based on the projection image data acquired when the radiation source and the radiation detector are moved in a forward stroke and a backward stroke along the subject from the perpendicularly positioned state, and in the displaying step, the interim tomographic image may be revised and displayed, each time the interim tomographic image is generated in the generating step.

The above and other objects, features, and advantages of the present invention will become more apparent from the following description when taken in conjunction with the accompanying drawings in which a preferred embodiment of the present invention is shown by way of illustrative example.

### BRIEF DESCRIPTION OF THE DRAWINGS

FIG. 1 is a block diagram of a radiographic image capturing system according to an embodiment of the present invention;

FIG. 2 is an enlarge diagram illustrative of a radiation source and a radiation conversion panel with respect to a subject and an image capturing base in the radiographic image capturing system shown in FIG. 1;

FIG. 3 is a flowchart of an operation sequence of the radiographic image capturing system shown in FIG. 1 for carrying out tomosynthesis image capturing;

FIGS. 4A to 4C are conceptual diagrams illustrative of a case in which data acquired by the radiographic image capturing system shown in FIG. 1 are output first from a position when the radiation source and the radiation conversion panel are perpendicular to the subject (perpendicular positions), and the data acquired on an initial position side and the data acquired on an end position side are transferred to an image processor step by step; and

FIGS. 5A to 5D are conceptual diagrams illustrative of the order in which the data acquired by the radiographic image capturing system shown in FIG. 1 are transferred to the image processor in a case in which the data are captured when the radiation source and the radiation conversion panel are positioned at the positions equally spaced from each other between the perpendicular positions and the initial positions, and between the perpendicular positions and the end positions.

### DESCRIPTION OF THE PREFERRED EMBODIMENTS

A radiographic image capturing system and a radiographic image capturing method according to preferred embodiments of the present invention will be described in detail below with reference to the accompanying drawings.

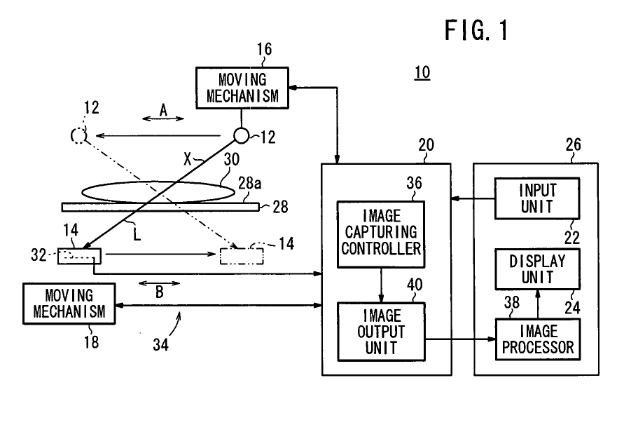

As shown in FIG. 1, a radiographic image capturing system 10 comprises a radiation source 12, a cassette 14, a first moving mechanism 16, a second moving mechanism 18, a control device 20, and a console 26 including an input unit 22 and a display unit 24.

The radiation source 12 emits radiation X such as an X-ray at a prescribed irradiation dose in response to a command from the control device 20. The cassette 14 detects the radiation X that has been emitted from the radiation source 12 and passed through a subject 30 (e.g., a patient) lying on a lying surface 28a of an image capturing base 28. The cassette 14 houses a radiation conversion panel (radiation detector) 32 therein that converts the detected radiation X into radiographic image information. The radiation conversion panel 32 outputs the converted radiographic image information to the control device 20. The first moving mechanism 16 moves the radiation source 12 in response to a command from the control device 20. The second moving mechanism 18 moves the cassette 14 in response to a command from the control device 20. A tomosynthesis image capturing assembly 34 is made up of the above-mentioned radiation source 12, the radiation conversion panel 32, the first moving mechanism 16, the second moving mechanism 18, and the control device 20 jointly.

The tomosynthesis image capturing assembly 34 is capable of operating in both a tomosynthesis image capturing process and a simple image capturing process. The tomosynthesis image capturing process is a process for acquiring the data of projection images for tomosynthesis, to be processed to reconstruct a tomographic image. The simple image capturing process is a process for acquiring the data of a projection image (front projection image) to be displayed as it is without the reconstruction of the image.

The control device 20 includes an image capturing controller 36 and an image output unit 40. An image processor (tomographic image reconstructing unit, interim tomographic image generator) 38 is provided in the console 26.

The image capturing controller 36 operates the radiation source 12, the radiation conversion panel 32, the first moving mechanism 16, and the second moving mechanism 18 to control the tomosynthesis image capturing process and the simple image capturing process. Specifically, in the tomosynthesis image capturing process, the image capturing controller 36 moves the radiation source 12 and the radiation conversion panel 32 synchronously in respective opposite directions with the subject 30 interposed therebetween while the direction in which the radiation source 12 applies the radiation X is being held approximately in alignment with a straight line L interconnecting the center of the radiation source 12 and the center of the radiation conversion panel 32.

In other words, the radiation source 12 and the cassette 14 housing the radiation conversion panel 32 therein move linearly in opposite horizontal directions (directions of arrows A and B), respectively, with the subject 30 disposed centrally between the radiation source 12 and the cassette 14.

While the radiation source 12 and the cassette 14 are being moved synchronously, the image capturing controller 36 instructs the radiation source 12 to emit the radiation X and also reads out the radiographic image information (the data of projection images) acquired by the radiation conversion panel 32.

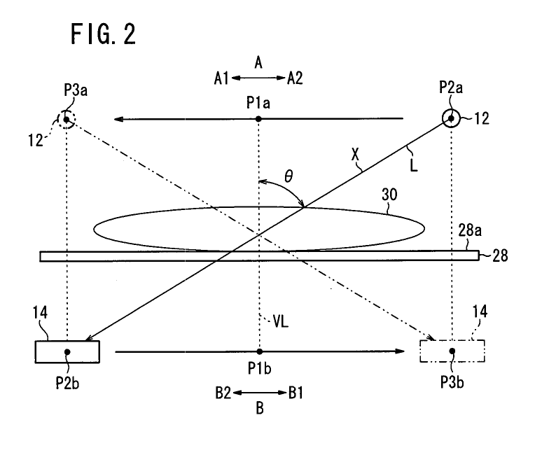

In the simple image capturing process, the image capturing controller 36 instructs the radiation source 12 to emit the radiation X at the dose required to acquire the data of a front projection image (projection image data) and also reads out the radiographic image information (the data of a front projection image) acquired by the radiation conversion panel 32. In the present embodiment, the tomosynthesis image capturing assembly 34 operates in the simple image capturing process when the straight line L interconnecting the radiation source 12 and the radiation conversion panel 32 is perpendicular to the lying surface 28a of the image capturing base 28, and the radiation source 12 reaches a perpendicular position P1a and the radiation conversion panel 32 reaches a corresponding position that is a perpendicular position P1b (see FIG. 2).

The projection image data, which are read out from the radiation conversion panel 32 by the image capturing controller 36, are input into the image output unit 40. The image output unit 40 selects data from the read projection image data, for outputting to the image processor 38 (interim tomographic image generator), and outputs the selected data step by step.

Generally, projection image data are output to the image processor 38 in the order in which the image capturing controller 36 acquires the data, and a tomographic image is reconstructed based on the output data. In the present embodiment, in contrast, projection image data read out from the radiation conversion panel 32 by the image capturing controller 36 are output to the image output unit 40, in a given order and step by step.

The image processor 38, for example, provided in the console 26, processes the projection image data that are read out from the radiation conversion panel 32 by the image capturing controller 36. Specifically, the image processor 38 processes the projection image data that are output from the image output unit 40 selectively and step by step according to a shift-and-add process or a filtered back projection (FBP) process, thereby acquiring a reconstructed tomographic image at a desired sectional position (slice height). After performing various image correcting processes on the reconstructed tomographic image, the image processor 38 outputs the processed tomographic image to the display unit 24 to be displayed thereon.

In this case, since the projection image data are transferred selectively and step by step from the image output unit 40, a part of the projection image data can be processed so that a partially-reconstructed tomographic image (interim tomographic image) can be acquired step by step. Together therewith, the transferred data are accumulated and the amount thereof is increased over time, and thereby a clearer tomographic image can be constructed gradually because of an increased amount of projection image data to be reconstructed. That is, since the image processor 38 processes a part of transferred data (projection image data) from the image output unit 40 step by step, the interim result of the tomographic image can be acquired before obtaining a complete tomographic image.

The input unit 22 serves as a mechanism to enter commands from a doctor for the tomosynthesis image capturing process. The input unit 22 may comprise operating buttons, a key board, a mouse, etc., for example.

The radiographic image capturing system 10 according to the present embodiment is basically configured as described above. Next, a process for carrying out the tomosynthesis image capturing process using the radiographic image capturing system 10 will be described below.

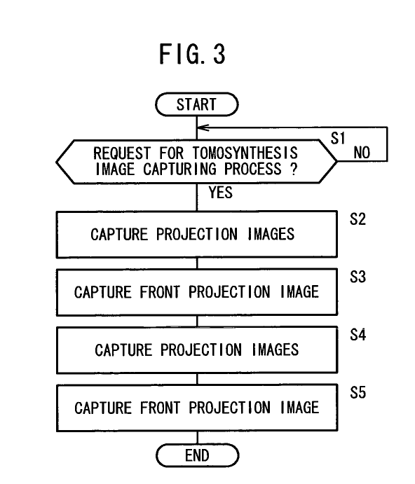

In step S1 shown in FIG. 3, the image capturing controller 36 of the control device 20 determines whether the doctor has entered a request for the tomosynthesis image capturing process into the input unit 22 or not. If the doctor has not entered a request for the tomosynthesis image capturing process into the input unit 22 (step S1: NO), then the image capturing controller 36 repeats step S1. If the doctor has entered a request for the tomosynthesis image capturing process into the input unit 22 (step S1: YES), then the image capturing controller 36 starts the tomosynthesis image capturing process in step S2.

As shown in FIG. 2, when the tomosynthesis image capturing process is carried out, the image capturing controller 36 actuates the first moving mechanism 16 and the second moving mechanism 18, for example, while the radiation source 12 and the radiation conversion panel 32 are inclined at a predetermined angle and positioned respectively at initial positions P2a, P2b, with the subject 30 interposed therebetween. In this case, the straight line L interconnecting the radiation source 12 and the radiation conversion panel 32 is inclined at the predetermined angle θ with respect to a perpendicular line VL interconnecting the radiation source 12 and the radiation conversion panel 32 when they are positioned respectively at the perpendicular positions P1a, P1b.

Then, as shown in FIG. 2, the image capturing controller 36 moves the radiation source 12 in the direction of arrow A1 and the radiation conversion panel 32 in the direction of arrow B1, synchronously in respective opposite directions, and instructs the radiation source 12 to emit the radiation X. The radiation X is applied to the subject 30, passes through the subject 30, and is detected by the radiation conversion panel 32. The image capturing controller 36 converts the detected radiation X into radiographic image information (the data of projection images). The radiographic image information is output from the image capturing controller 36 to the image output unit 40.

During the tomosynthesis image capturing process, when the radiation source 12 reaches the perpendicular position P1a which is perpendicular to the lying surface 28a of the image capturing base 28, and the radiation conversion panel 32 reaches the corresponding perpendicular position P1b that is vertically aligned with the perpendicular position P1a, the control device 20 controls the radiation source 12 to increase the dose of the emitted radiation X and starts the simple image capturing process to acquire the data of a first front projection image (still image) in step S3.

In following step S4, the control device 20 actuates the first moving mechanism 16 and the second moving mechanism 18 again to move the radiation source 12 in the direction of arrow A1 and the radiation conversion panel 32 in the direction of arrow B1, synchronously in respective opposite directions, thereby resuming the tomosynthesis image capturing process. The tomosynthesis image capturing process is finished when the radiation source 12 and the radiation conversion panel 32 reach end positions P3a, P3b, respectively. Then, the control device 20 actuates the first moving mechanism 16 and the second moving mechanism 18 to move the radiation source 12 and the radiation conversion panel 32 synchronously toward the initial positions P2a, P2b. When the radiation source 12 and the radiation conversion panel 32 reach again the perpendicular position P1a, P1b, respectively, the control device 20 controls the radiation source 12 to increase the dose of the emitted radiation X and starts the simple image capturing process to acquire the data of a second front projection image in step S5.

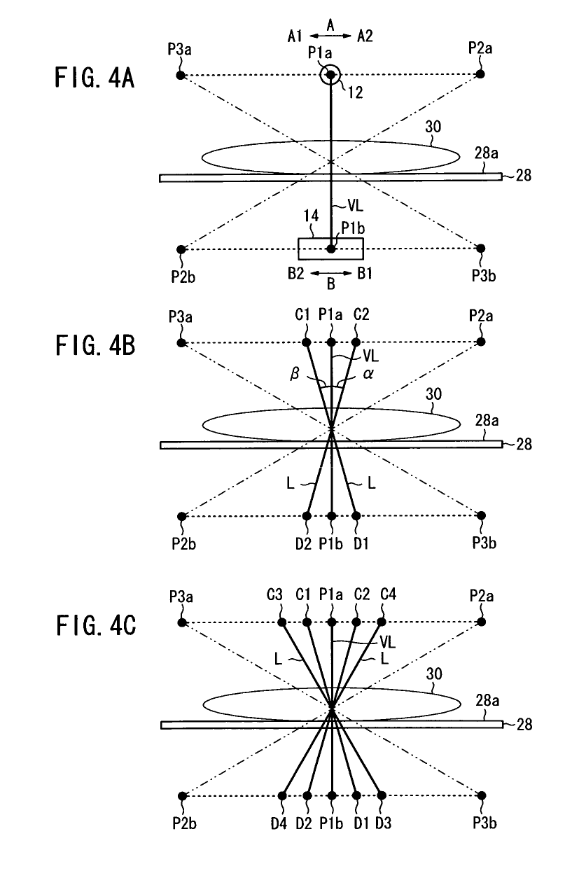

When the projection image data are output from the image output unit 40 to the image processor 38, the data captured by the radiation source 12 and the radiation conversion panel 32 that are perpendicularly positioned to the subject 30 at the perpendicular positions P1a, P1b, respectively, are output from the image output unit 40 through the image processor 38 to be displayed on the display unit 24, as shown in FIG. 4A. Since the simple image capturing process is carried out at the perpendicular positions P1a, P1b, the acquired front projection image is displayed as it is (referred to as a first interim tomographic image, for a descriptive purpose), without the reconstruction of the data thereof by the image processor 38, as a partial tomographic image.

Next, as shown in FIG. 4B, the data (projection image data) captured by the radiation source 12 and the radiation conversion panel 32 at positions C1, D1, respectively, are output from the image output unit 40 to the image processor 38. The position C1 of the radiation source 12 is shifted from the perpendicular position P1a toward the end position P3a in the direction of arrow A1, and the position D1 of the cassette 14 housing the radiation conversion panel 32 is shifted from the perpendicular position P1b toward the end position P3b in the direction of arrow B1. The straight line L interconnecting the radiation source 12 at the position C1 and the radiation conversion panel 32 (cassette 14) at the position D1 is inclined at a predetermined angle β with respect to the perpendicular line VL interconnecting the radiation source 12 and the radiation conversion panel 32 when they are positioned respectively at the perpendicular positions P1a, P1b. The image processor 38 processes the projection image data according to the shift-and-add process or the filtered back projection (FBP) process, combined with the first interim tomographic image, thereby acquiring a reconstructed second interim tomographic image constituting a partial tomographic image. Further, the data (projection image data) captured by the radiation source 12 and the radiation conversion panel 32 at positions C2, D2, respectively, are output from the image output unit 40 to the image processor 38. The position C2 of the radiation source 12 is shifted from the perpendicular position P1a toward the initial position P2a in the direction of arrow A2, and the position D2 of the radiation conversion panel 32 is shifted from the perpendicular position P1b toward the initial position P2b in the direction of arrow B2. The straight line L interconnecting the radiation source 12 at the position C2 and the radiation conversion panel 32 at the position D2 is inclined at a predetermined angle α (α=β) with respect to the perpendicular line VL interconnecting the radiation source 12 and the radiation conversion panel 32 positioned respectively at the perpendicular positions P1a, P1b. The image processor 38 processes the projection image data, combined with the second interim tomographic image, thereby acquiring a reconstructed third interim tomographic image constituting a partial tomographic image.

Incidentally, the second and third interim tomographic images are reconstructed based on the data which are captured by the radiation source 12 and the radiation conversion panel 32 when they are positioned respectively at positions that are symmetrical with respect to the perpendicular positions P1a, P1b (see FIG. 4B).

The partial tomographic image (the third interim tomographic image) thus acquired is output to the display unit 24, and displayed on the display unit 24, by replacing (revising) the first interim tomographic image, which has been displayed in advance as a partial tomographic image. The tomographic image now displayed on the display unit 24 is clearer than the image showing the first interim tomographic image only.

Further, as shown in FIG. 4C, the data captured by the radiation source 12 and the radiation conversion panel 32 at positions C3, D3, respectively, are output from the image output unit 40 to the image processor 38. The position C3 of the radiation source 12 is further shifted from the perpendicular position P1a toward the end position P3a in the direction of arrow A1, and the position D3 of the radiation conversion panel 32 is further shifted from the perpendicular position P1b toward the end position P3b in the direction of arrow B1. The image processor 38 processes the projection image data, combined with the third interim tomographic image, thereby acquiring a reconstructed fourth interim tomographic image constituting a partial tomographic image. Further, the data captured by the radiation source 12 and the radiation conversion panel 32 at positions C4, D4, respectively, are output from the image output unit 40 to the image processor 38. The position C4 of the radiation source 12 is shifted from the perpendicular position P1a toward the initial position P2a in the direction of arrow A2, and the position D4 of the radiation conversion panel 32 is shifted from the perpendicular position P1b toward the initial position P2b in the direction of arrow B2. The image processor 38 processes the projection image data, combined with the fourth interim tomographic image, thereby acquiring a reconstructed fifth interim tomographic image constituting a partial tomographic image. The fourth and fifth interim tomographic images are reconstructed based on the data which are captured by the radiation source 12 and the radiation conversion panel 32 when they are positioned respectively at positions that are symmetrical with respect to the perpendicular positions P1a, P1b (see FIG. 4C).

Similarly, the partial tomographic image (the fifth interim tomographic image) thus acquired is output to the display unit 24, and displayed on the display unit 24, by replacing the third interim tomographic image, which has been displayed in advance as also a partial tomographic image. Accordingly, a partial tomographic image acquired by capturing an affected area of the subject 30 can be displayed on the display unit 24 step by step as an interim result for confirmation.

By outputting to and displaying on the display unit 24 each of the partial tomographic images that are reconstructed step by step, the tomographic image is generated gradually from plural pieces of projection images that are added step by step, and changed into a clearer tomographic image.

That is, for example, the data (front projection image) are captured by the radiation source 12 and the radiation conversion panel 32 when they are positioned at the perpendicular positions P1a, P1b, respectively, which are positioned centrally between the initial positions P2a, P2b and the end positions P3a, P3b. The captured data are first output from the image output unit 40 through the image processor 38 to be displayed on the display unit 24 as the interim tomographic image. Further, the data are captured by the radiation source 12 and the radiation conversion panel 32 at the positions that are at first close to the perpendicular positions P1a, P1b but are shifted progressively toward the initial positions P2a, P2b and the end positions P3a, P3b, respectively. The captured data are output step by step from the image output unit 40 to the image processor 38 and processed for reconstruction. Thus, each of the partial tomographic images can be reconstructed and displayed on the display unit 24 step by step, and projection images acquired by capturing an affected area of the subject 30 can be displayed on the display unit 24 step by step as an interim tomographic image that is an interim result for a complete tomographic image.

Stated otherwise, the data are captured by the radiation source 12 and the radiation conversion panel 32 at the positions that are perpendicular to the subject 30, i.e., at the perpendicular positions P1a, P1b, respectively, and at the positions that are shifted progressively toward the initial positions P2a, P2b and the end positions P3a, P3b, respectively. The captured data are output to and processed in the image processor 38 step by step, thereby acquiring tomographic images (interim tomographic images) step by step.

Lastly, after the complete tomographic image reconstructed from projection image data is displayed on the display unit 24, the doctor operates the input unit 22 to enter a command that recapturing is unnecessary. Then, the control device 20 finishes the image capturing process (the tomosynthesis image capturing process and the simple image capturing process).

As mentioned above, in the present embodiment, while the radiation source 12 and the radiation conversion panel 32 are moved synchronously in respective opposite directions with the subject 30 interposed therebetween, images of the subject 30 are continuously captured by irradiating the subject 30 with the radiation from the radiation source 12, and the converted radiographic image information is output to the image output unit 40 by the image capturing controller 36. Together therewith, the radiographic image information is output from the image output unit 40 selectively and step by step to the image processor 38. The image processor 38 processes the radiographic image information, and acquires a reconstructed tomographic image each time. The reconstructed tomographic image (interim tomographic image) can be displayed on the display unit 24 step by step.

Accordingly, since the captured result of the tomographic image can be confirmed in an interim step before the completion of capturing the whole image, it can be quickly confirmed whether the captured result is appropriate or not. Consequently, even if an appropriate radiographic image cannot be obtained, for example, due to the unwanted movement of the subject 30 from a predetermined position during the image capturing, it is possible to quickly judge that the image capturing should be discontinued or stopped based on the interim result of the tomographic image. Thus, it is possible to avoid a troublesome case in which after capturing the image the subject 30 should be brought back for recapturing the image. Also, the burden on the subject 30 can be reduced.

Further, since it is possible to quickly judge whether the captured result is appropriate or not, the time required for an image capturing operation can be used efficiently, compared to a conventional technique in which the captured result cannot be confirmed until after the capturing of the image has been completed. Thus, the efficiency of the image capturing operation can be increased.

Further, when the data selected by the image output unit 40 are transferred to the image processor 38, the data acquired in the simple image capturing process by the radiation source 12 and the radiation conversion panel 32 that are positioned at the perpendicular positions P1a, P1b, respectively, are transferred first. Since the first-transferred data do not have to be processed by the image processor 38 for reconstruction, it is possible to display the partial tomographic image (first interim tomographic image) on the display unit 24 clearly and readily, and a doctor and the like can confirm the image easily.

Further, two sets of data (e.g., the data captured by the radiation source 12 at the position C1 and the position C2) are transferred to the image processor 38, and the tomographic image is reconstructed based on the two sets of data. The two sets of data are captured by the radiation source 12 and the radiation conversion panel 32 when they are positioned respectively at the positions on the initial position (P2a, P2b) side and the end position (P3a, P3b) side that are symmetrical with respect to the perpendicular positions P1a, P1b. This is preferable since it is possible to acquire a clearer tomographic image.

Further, in the present embodiment mentioned above, one example has been described, in which the radiographic image information captured by the radiation source 12 and the radiation conversion panel 32 that are perpendicularly positioned to the subject 30 and the image capturing base 28 at the perpendicular positions P1a, P1b, respectively, is first output to the image processor 38, and thereafter the data captured by the radiation source 12 and the radiation conversion panel 32 at the positions that are shifted progressively toward the initial positions P2a, P2b and the end positions P3a, P3b, respectively, from the perpendicular positions P1a, P1b are step by step output to the image processor 38, for reconstructing a tomographic image. The present invention, however, is not limited to this embodiment.

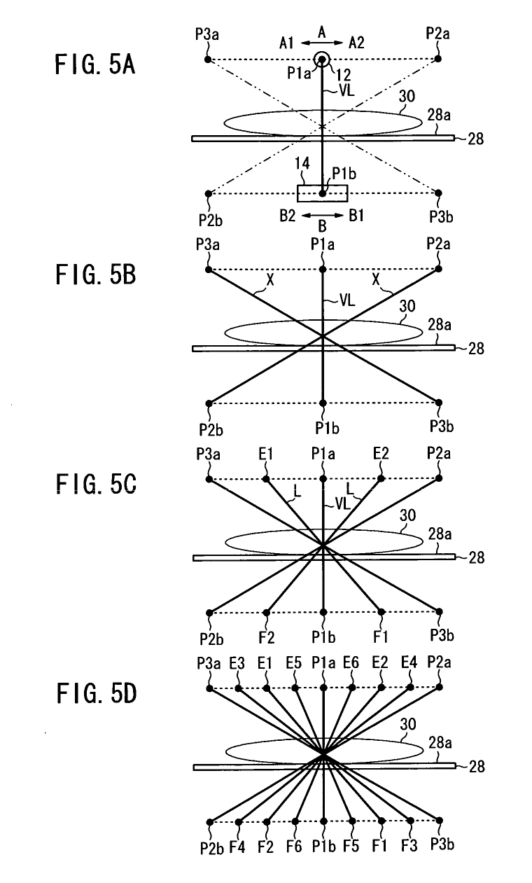

For example, as shown in FIG. 5A, the data (projection image data) captured by the radiation source 12 and the radiation conversion panel 32 that are positioned at the perpendicular positions P1a, P1b, respectively, are output to the image processor 38 to acquire the first interim tomographic image as a partial tomographic image. Thereafter, as shown in FIG. 5B, the data captured by the radiation source 12 and the radiation conversion panel 32 at the positions that are positioned at the initial positions P2a, P2b and the end positions P3a, P3b, respectively, are transferred to the image processor 38. The image processor 38 processes the projection image data, combined with the first interim tomographic image, acquires reconstructed second and third interim tomographic images as partial tomographic images, and displays the third interim tomographic image on the display unit 24 by replacing the first interim tomographic image.

Thereafter, as shown in FIG. 5C, data captured by the radiation source 12 and the radiation conversion panel 32 at first middle positions E1, F1, respectively, are output to the image processor 38. The first middle position E1 of the radiation source 12 is positioned at the midpoint between the perpendicular position P1a and the end position P3a. The first middle position F1 of the radiation conversion panel 32 is positioned at the midpoint between the perpendicular position P1b and the end position P3b. The image processor 38 processes the projection image data, combined with the third interim tomographic image, thereby acquiring a reconstructed fourth interim tomographic image constituting a partial tomographic image. Then, data captured by the radiation source 12 and the radiation conversion panel 32 at second middle positions E2, F2, respectively, are output to the image processor 38. The first middle position E2 of the radiation source 12 is positioned at the midpoint between the perpendicular position P1a and the initial position P2a. The first middle position F2 of the radiation conversion panel 32 is positioned at the midpoint between the perpendicular position P1b and the initial position P2b. The image processor 38 processes the projection image data, combined with the fourth interim tomographic image, thereby acquiring a reconstructed fifth interim tomographic image constituting a partial tomographic image.

The partial tomographic image (the fifth interim tomographic image) thus acquired is output to the display unit 24, and displayed on the display unit 24, by replacing the third interim tomographic image, which has been displayed in advance as a partial tomographic image.

Thereafter, as shown in FIG. 5D, data captured by the radiation source 12 and the radiation conversion panel 32 at second middle positions E3, F3, respectively, are output to the image processor 38. The second middle position E3 of the radiation source 12 is positioned at the midpoint between the first middle position E1 and the end position P3a. The first middle position F3 of the radiation conversion panel 32 is positioned at the midpoint between the first middle position F1 and the end position P3b. The image processor 38 processes the projection image data, combined with the fifth interim tomographic image, thereby acquiring a reconstructed sixth interim tomographic image constituting a partial tomographic image. Then, data captured by the radiation source 12 and the radiation conversion panel 32 at second middle positions E4, F4, respectively, are output to the image processor 38. The second middle positions E4, F4 are symmetrical to the second middle positions E3, F3 with respect to the perpendicular positions P1a, P1b, respectively, and are shifted toward the initial positions P2a, P2b. The image processor 38 processes the projection image data acquired at the second middle positions E4, F4, combined with the sixth interim tomographic image, thereby acquiring a reconstructed seventh interim tomographic image constituting a partial tomographic image. The partial tomographic image (the seventh interim tomographic image) thus acquired is output to the display unit 24, and displayed on the display unit 24, by replacing the fifth interim tomographic image, which has been displayed in advance as a partial tomographic image.

On the other hand, data captured by the radiation source 12 and the radiation conversion panel 32 at third middle positions E5, F5, respectively, are transferred to the image processor 38. The third middle position E5 of the radiation source 12 is positioned at the midpoint between the first middle position E1 and the perpendicular position P1a. The third middle position F5 of the radiation conversion panel 32 is positioned at the midpoint between the first middle position F1 and the perpendicular position P1b. The image processor 38 processes the projection image data, combined with the seventh interim tomographic image, thereby acquiring a reconstructed eighth interim tomographic image constituting a partial tomographic image. Also, data captured by the radiation source 12 and the radiation conversion panel 32 at third middle positions E6, F6, respectively, are output to the image processor 38. The third middle positions E6, F6 are symmetrical to the third middle positions E5, F5 with respect to the perpendicular positions P1a, P1b, respectively, and are shifted toward the initial positions P2a, P2b. The image processor 38 processes the projection image data acquired at the third middle positions E6, F6, combined with the eighth interim tomographic image, thereby acquiring a reconstructed ninth interim tomographic image constituting a partial tomographic image. The partial tomographic image (the ninth interim tomographic image) thus acquired is output to the display unit 24, and displayed on the display unit 24, by replacing the seventh interim tomographic image, which has been displayed in advance as a partial tomographic image.

In this way, the data may be captured by the radiation source 12 and the radiation conversion panel 32 at the positions that divides equally between the initial positions P2a, P2b and the end positions P3a, P3b with the perpendicular positions P1a, P1b interposed centrally. Then, the respective captured data are output to the image processor 38 for constituting partial tomographic images. In this way, each of the partial tomographic images can be displayed on the display unit 24 step by step, and each of the partial tomographic images acquired by capturing the images of the subject 30 can be displayed on the display unit 24 as an interim result.

In the tomosynthesis image capturing using the radiographic image capturing system 10 described above, the radiation source 12 and the radiation conversion panel 32 are moved for capturing the image of the subject 30. In this description, the radiation source 12 and the radiation conversion panel 32 are moved synchronously to the left and right of, and at the same angles with respect to, the perpendicular line VL interconnecting the radiation source 12 and the radiation conversion panel 32 when they are perpendicularly positioned to the subject 30. The tomosynthesis image capturing using the radiographic image capturing system 10, however, is not limited to this way of image capturing. For example, the projection images may be captured while the radiation source 12 is moved from a left end to a right end of a path along which the radiation source 12 moves, and the radiation conversion panel 32 is moved synchronously from a right end to a left end of a path along which the radiation conversion panel 32 moves. Alternatively, a pair of the radiation source 12 and the radiation conversion panel 32 may be moved synchronously to the left from the center together, and to the right from the center together.

Although a certain preferred embodiment of a radiographic image capturing system and a radiographic image capturing method according to the present invention has been shown and described in detail, it should be understood that various changes and modifications may be made therein without departing from the scope of the appended claims.

What is claimed is:

1. A radiographic image capturing system comprising:
a radiation source for applying radiation to a subject at a plurality of different angles with respect to the subject;
a radiation detector for detecting the radiation which has passed through the subject, and acquiring projection image data;
a tomographic image reconstructing unit for processing the projection image data into a reconstructed tomographic image; and
a display unit,
the tomographic image reconstructing unit including an interim tomographic image generator for generating an interim tomographic image by combining the acquired projection image data with at least one set of other projection image data acquired in advance, each time the projection image data are acquired, and
the display unit revising and displaying the interim tomographic image generated by the interim tomographic image generator, each time the projection image data are acquired.

2. A radiographic image capturing system according to claim 1, wherein the interim tomographic image generator generates the interim tomographic image from at least a pair of the sets of the projection image data acquired by the radiation source and the radiation detector when the radiation source and the radiation detector are positioned respectively at positions that are symmetrical with respect to a reference state of the radiation source and the radiation detector, and wherein in the reference state, the radiation source and the radiation detector are positioned perpendicularly to the subject.

3. A radiographic image capturing system according to claim 1, wherein the tomographic image reconstructing unit and the display unit are provided in a console that is separate from a tomosynthesis image capturing assembly.

4. A radiographic image capturing system according to claim 1, further comprising:
a first moving mechanism for moving the radiation source in a forward stroke and a backward stroke along the subject;
a second moving mechanism disposed on an opposite side of the subject from the first moving mechanism, for moving the radiation detector in a direction opposite to a direction in which the first moving mechanism moves the radiation source.

5. A radiographic image capturing method, wherein radiation is applied to a subject at a plurality of different angles with respect to the subject, and the radiation which has passed through the subject is detected, the method comprising the steps of:
converting the detected radiation at the different angles into respective sets of projection image data;
generating an interim tomographic image based on the projection image data selectively output from among the sets of converted projection image data; and
displaying the generated interim tomographic image.

6. A radiographic image capturing method according to claim 5, wherein in the generating step, after a first interim tomographic image is generated from the projection image data acquired in a state in which a radiation source and a radiation detector are positioned perpendicularly to the subject, a next interim tomographic image is generated step by step based on the projection image data acquired when the radiation source and the radiation detector are moved in a forward stroke and a backward stroke along the subject from the perpendicularly positioned state; and
wherein in the displaying step, the interim tomographic image is revised and displayed, each time the interim tomographic image is generated in the generating step.
